(19) United States
(12) Patent Application Publication
(10) Pub. No.: US 2025/0371985 A1
(43) Pub. Date: Dec. 4, 2025

(54) Method and System for Multi-Administration of Automatic High-Speed Safety System for Unstaffed or Closed Airfields

(71) Applicant: John Fisher, Hailsham (GB)

(72) Inventor: John Fisher, Hailsham (GB)

(21) Appl. No.: 19/225,312

(22) Filed: Jun. 2, 2025

Related U.S. Application Data
(60) Provisional application No. 63/656,029, filed on Jun. 4, 2024.

(51) Int. Cl. G08G 5/54; G08G 5/26

(52) U.S. Cl. CPC G08G 5/54; G08G 5/26

(57) ABSTRACT

An automatic high-speed safety system. The system has at least one microprocessor and first and second storage locations. The microprocessor is preprogrammed with instructions to receive and load into the storage medium data comprising an aircraft operator provided aircraft type, aircraft owner ID and destination, and then to compare the data from the first storage location with data in the second storage location comprising a table of airfield destination data, and to provide, from the comparison, a package of data for use in preparing and issuing a Prior Permission Request for the operator to land the aircraft at the destination.

### CROSS REFERENCE TO RELATED APPLICATIONS

This application claims priority to U.S. Provisional Patent application 63/656,029 filed Jun. 4, 2024.

### TECHNICAL FIELD

The disclosure relates to the field of airfield management and safety and to aircraft seeking or requiring permission to land at non-towered airfields or at unstaffed or closed airfields; in particular it relates to method and system for multi-administration of automatic high-speed safety system for unstaffed or closed airfields.

### BACKGROUND

With few exceptions, aircraft are presently denied permission (FAA/CAA rules) to land at unstaffed or closed airfields, particularly if such airfields are also non-towered. In some cases, a pilot may secure the issue of a PPR (Prior Permission Request) for a specific airfield and land there at the appointed time in the registered aircraft, even if the airfield is closed or otherwise unstaffed. There are no other known approved means to do so, especially not automatic, continuously available means. Though bona fide Emergency Landings may in some jurisdictions be regarded as notable exceptions, no known means of doing so are generally regarded as safe.

However the procedure and regulations surrounding issuance of such a PPR are cumbersome at best, and quite unsuited to spontaneous, on-the-fly navigation and route planning.

In addition, the current methods used for billing, collecting and paying landing fees, management of parking and take-off fees and pre-apportionment of liabilities, are not automated to any useful extent, and impossible at small or private airfields, especially if they are unstaffed or closed.

What is needed is a method and system for automatic, continuously available, on-the-fly, issue of PPRs (Prior Permission Requests) for unstaffed or non-towered airfields (or airfields threatened with closure, or already closed).

### DISCLOSURE

A method and system for automatic issue of PPRs (Prior Permission Requests) for unstaffed or non-towered airfields (or airfields threatened with closure, or already closed) are disclosed. Optional automated collection and payment of Airfield service fees, advance apportionment of landing liabilities and other airfield administrative data are also provided.

Optimally, the disclosed method and system are effective without any mechanical installations or equipment required at or by the airfield so that unstaffed and or non-towered airfields and the like are enabled to remain open and available for safely and automatically receiving incoming aircraft.

In practice, necessary data (such as coordinates and codes) are received by at least one processor on a remote server or servers, and stored on at least one storage device operatively connected to the server(s). Manipulation, calculation and performance of the functions of the method and system are performed through a custom application (App) running on the server. Exchange of data with owners/operators of airfields may be accomplished by a separate computing device having its own storage and processor operatively connected to the remote server and processor via a custom application (App). Provision is made to have this data sent to and received by a mobile computing device having its own storage and processor operatively connected wirelessly via a custom application (App) to the remote server and processor. The custom applications on the computing devices of airfield owner/operators and pilots may also perform functions of the method and system.

Alternatively, the separate or mobile computing devices may access an application implemented on a website. For the sake of simplicity, “App” will be used to describe processes performed as either an application running on the mobile device and remote servers, or accessed as a website through a browsing application on the mobile device and running on the remote server.

Optionally, wireless location determining functions and location data delivery functions operating on the mobile computing device, most probably via the GPS, will also be available to the App. In addition, data provided by other applications (such as GPS location applications) running on the mobile device may also be used. Wireless communication with equipment on board an App user's (pilot's) aircraft, other aircraft, or at various airfields or other locations may be integrated into the system. Such equipment might include, but is not limited to, a GPS Beacon, altimeter, magnetic compass, navaid, transponder, Vertical Speed Indicator/variometer, a VOR, or any equipment capable of sending relevant data digitally.

In a particular case, an App user (pilot) receives on the mobile device a spontaneously updated list of available airfields, which is displayed, and selects a desired destination airfield from the list during the flight planning stage. Optionally, the pilot's selection is then sent to the remote server and processor and stored, or the selection may be stored on the mobile device only. Alternatively, the App user selects a desired destination airfield from a pre-selected list or from a menu previously stored on the mobile device. Optionally, an App user may continuously receive an updated list of available airfields, or may receive such updates at regularly timed intervals or may receive an updated list of available airfields through a request routine on the App. Desirably, a new airfield destination may be selected and entered into the App during flight, due to mid-flight changes in plan, or to low-level emergency, or due to the continuous or regularly-timed update of available airfield locations not previously displayed on the App list or menu.

Optimally, all available requisite airfield parameters, such as elevation (ASL), wind speed and direction, runway coordinates with or without unique codes, and the like, become available for use by the App. Data may be received by the App running on the mobile device through interaction with the remote server or, advantageously, through wireless communication with equipment at the airfield or elsewhere. The airfield parameters are stored and can be displayed on the mobile device.

If not already entered as default, the pilot's aircraft type is sent to the server, along with requisite data such as weight and stall speed, and an automated PPR is then requested and automatically granted, the grant subject only to airfield landing availability at the chosen airfield at the chosen ETA landing time. The pilot is notified the PPR is granted through receipt by the mobile device and display through the App. Optionally, notice that a PPR has been granted will be sent to the airfield owner/operator App from the server or the mobile device.

The collection of payments from the aircraft owner's registered account is automatically performed by the App and/or connected server after the aircraft arrives over a GPS ID Code point (if available), follows a predetermined sequence of unique GPS Beacons just before the beginning of the runway, continues along the runway center line reaching a critical point that matches another GPS ID Code, and reaches stalling speed which, for simplicity's sake, is taken to mean that the aircraft has shortly thereafter touched down on the runway. Optional provision is made for reset in the event that the approaching aircraft executes some kind of missed approach or other touch down and or landing avoidance. Optionally, operative communication between other applications on the mobile device may be used to track, store and calculate the necessary data. Optionally, wireless communication between the App running on the mobile device and various equipment at the airfield or other locations may also be used.

Once the App detects a “match” of above said parameters, five digital gates in the App close the flight plan and the PPR and may simultaneously trigger any of the following airfield administration chain: debit of fees through Stripe or the like billing software and systems, automatic billing and debit of fees from the aircraft owner, credit to the account of airfield owner, sending landing time and runway identities to an airfield control tower computing device, sending data to the airfield “log book”, sending details to Department of Civil aviation, sending end-user details and digital statistics to the Airfield owner's digital equipment, sending the aircraft length of flight time to maintenance services, triggering a timer to record the beginning of parking time that is closed by aircraft departure on reaching (by way of example for presumptive take-off) 500 feet altitude which triggers a take-off fee debit of the aircraft owner's account, and generates and sends a receipt to the aircraft owner, the airfield owner/operator or both. Optionally, transactions may be sent to the airfield's bookkeeping program (i.e. Sage). All landings and the runways used may be stored by the App, or sent for use by another application (such as in an Excel file), and auto converted to statistics of landings, aircraft types, mission, runways used, length of stay and fuel purchased.

The disclosed method and system enables unstaffed or non-towered airfields to operate without staff but still issue PPRs and collect fees for services such as, but not limited to, landing, take-off, ramp, parking, fueling and for other incidental passenger charges. Opening and closing times are also available to the App. In practice, the App desirably recognizes a correlation of GPS beacon locations and proprietary airfield system codes that trigger the debit of a pre-designated aircraft owner's account and credit the airfield owner/operator's account.

Optimally, aircraft data such as stall speed, runway requirements, and other parameters associated with a specific model or type of aircraft, may be stored in a database operatively connected to the server or the mobile device. When a pilot inputs his model or type of aircraft this data may be automatically generated and stored for use with a pilot's account.

In an alternative disclosed application, after selection of a destination field, input of a take-off field (if not already loaded by default), and input of aircraft data such as stall speed, tail number, model and type of aircraft, an instance of the App is automatically activated upon detection of take-off data (for example, detection of altitude of ASL+ X feet or Y miles from GPS coordinates of take-off field). Each datum is instantaneously compared with pre-programmed threshold parameters, such as the ones mentioned, so that a take-off datum is determined and stored. The App then automatically and continuously or repetitively monitors relevant data, such as GPS position, altitude, and airspeed, and continually or repetitively compares these data with the stored landing field data. Optimally, the App instantly displays an alert when the selected airfield is being approached. The suitability for safe landing at the selected field and or physical capability for the input aircraft is also automatically checked, before the PPR is automatically generated, and sent in advance to the authority associated with the selected airfield.

Relevant flight data as described above may be received either by a mobile device or by a remote server. It may be received from one or more mobile devices by a server or vice versa. It may be received through wireless connection from equipment at the destination or take-off airfields, or equipment on board the aircraft.

An optional emergency landing function may be manually triggered by the pilot to shift the App from monitoring for the selected landing field to monitoring for the nearest landing field physically capable of handling a safe landing for the input aircraft, and the monitoring proceeds as above, except it is for the emergency field automatically determined by the App.

Optionally in the App, other pilots/aircraft who have selected the same airfield destination for landing within a predetermined time (for example, within 15 minutes) of an earlier-granted PPR's planned arrival time, receive an SMS (or an message inside the App, or the like) stating that another aircraft is expected to arrive at about the same time. They are then automatically and instantaneously prioritized electronically as first come, first served. When a pilot selects the planned destination and ETA landing time, the destination airfield ATC sees the latest aircraft PPR at the bottom of their list (what is termed an “Electronic Board” or Dashboard). Advantageously, unstaffed airfields are monitored by owners on their mobile devices and are so indicated via the App to pilots.

Optionally, in the event a predetermined number (for instance, three) of aircraft select the same destination and receive their PPR approvals, any fourth aircraft automatically receives a PPR 30 minutes later. The fourth pilot can accept or reject/cancel that destination. Cancellation then automatically removes that aircraft from the electronic board.

Optionally, when a pilot selects a destination and the destination airfield parameters are loaded, s/he enters the ETA in the ETA Field. This triggers a PPR with all pilot and Aircraft details. For purposes of indemnification of airfield operators/owners, the App sends a message that the pilot has read and understood the airfield's rules and has visited the airfield website (if any) and, by accepting the offered PPR, thus indemnifies the airfield against damages due to the pilot's landing or departure. Pilot and aircraft details are filled automatically from the pilot App. Only the ETA has to be added which copies into the PPR and triggers the PPR grant.

Once on approach (as defined by preprogrammatically entered approach data), the App switches automatically to approach and landing mode and a series of pre-loaded altitude and or locational (i.e. GPS) data (in accordance with the selected airfield) are continuously or repetitively monitored. As each datum is determined to match a preprogrammed landing status assessment for the particular airfield, its achievement is automatically and instantaneously stored in a landing matrix. The matrix is continuously or repetitively monitored and when it is full, the landing is automatically and instantaneously accorded “landed” status and all actions and documents and payments associated with that status are automatically and instantaneously executed and the instance of the App is automatically closed or, optionally, automatically switches into a “standby” mode.

### BRIEF DESCRIPTION OF THE DRAWINGS

FIG. 1 is a schematic overview of the App architecture.

FIG. 2 schematically illustrates how an aircraft crosses beacon coordinates and registers with the logic gates.

FIG. 3 schematically illustrates conditions required to trigger payment for airfield services.

FIG. 4 is a flowchart of business flow of collecting airfield service fees.

FIGS. 5, 6 and 7 are schematic details of the flow shown in FIG. 4.

### DETAILED DESCRIPTION

“Airfield” as used herein includes but is not limited to small airports, airfields, airstrips, non-towered airports, private fields, helipads and farm airstrips.

Airfield Operators/Owners can download the disclosed airfield administrative platform onto control tower computers, or mobile devices such as cell phones and tablets allowing the airfield to also be monitored remotely.

Airfield data can be entered by the Airfield Operators/Owners and Pilots' Interface devices.

The App shows all airfields that are participating in the system. On selection of a destination airfield pre-authorization parameters and codes are uploaded from the server onto the mobile device and a PPR is sent to the pilot via the App and also desirably copied to the authority of the selected airfield.

In operation for flight, the aircraft takes off from the start airfield. On reaching 500 feet above the airdrome, the App triggers an SMS to the destination airfield showing aircraft class, ID, and ETA to confirm the PPR sent earlier. The system verifies the airfield ID and completed landing to trigger payment of fees. The system after landing sends multiple digital Docs (bills, accounts, logs, statistics) to all parties. The system is useful to general aviation and enables an otherwise unavailable income stream to unused or private airfields, and non-towered airports. The system also allows private airstrips to enter the general aviation sector, thus increasing both business and recreational destinations and possible extra emergency landing places.

Selected features of the disclosed method and system (not exclusive and not exhaustive):

The App reads a plurality of GPS data such as Coordinates at five strategic points which are not a simple Geo-Fence (Cross a line) concept but on the approach and runway threshold and along the runway where Aircraft unavoidably has to pass to land and codes are read as follows;
GPS Beacon position that Identifies Airfield by code,
GPS Beacon position that shows intent to land,
GPS Beacon position at beginning of runway,
GPS Beacon position 120 yard along center line of runway-committed to land,
GPS Beacon 240 yards long runway to read a final code for the system;
Touch down established as an aircraft reaches stalling speed, whereby it ceases to fly. This sequence creates a five “YES status” in the pilot's App.

The software detects the five “YES” outputs and triggers automatically some or all of the following:
Automatic Payment of Landing Fees and Services to airport owner
Automatic Billing for the airport and bookkeeping entry
A unique database record of the Aircraft type and ID held in the App.
A logbook record of the landing for the Airport Owner
An accumulation of landings and take-offs provide statistics for the airdrome

Disclosed system sampling GPS coordinates is not to be confused with a GPS navigation service nor with so-called Geo-Fencing descriptions which are only two dimensional (as for example, a car crossing a GPS line or opening a barrier or gate and paying a parking fee). In contrast, the disclosed system and method operate in a three dimensions, with height and speed joining the equation plus two codes unique to the airfield and aircraft type respectively, and to which the App instantaneously correlates the above data and triggers the above sequence.

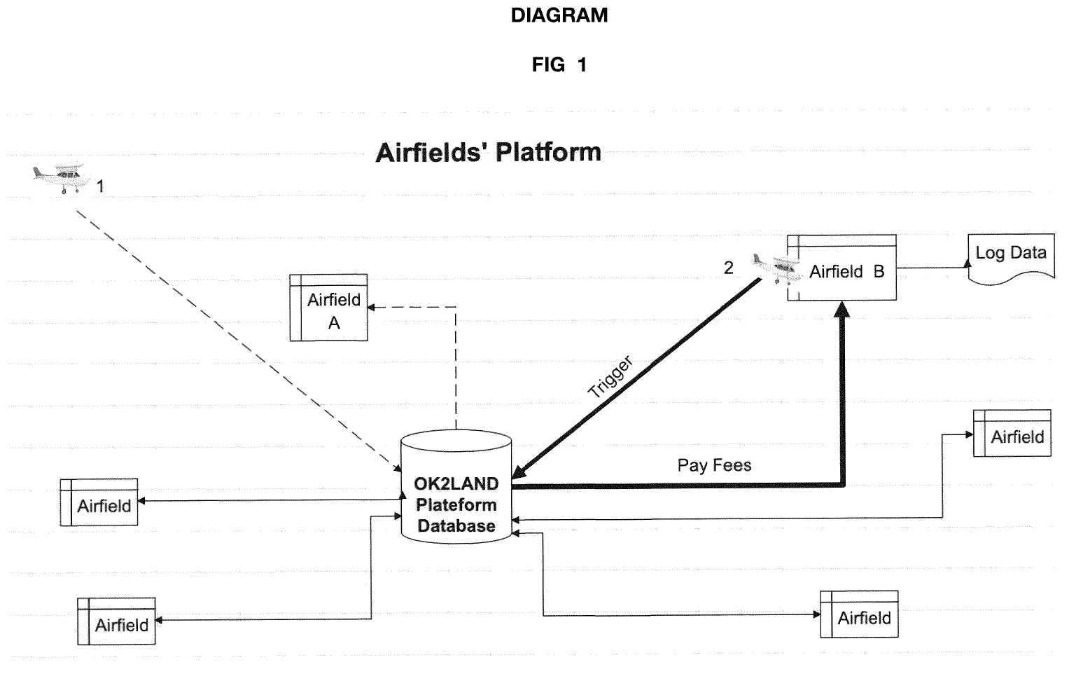

FIG. 1 is an overview of the Airfield and Mobile Interface App architecture and the interaction between them. The center hub is a powerful server database connected on-line to all member Airfields. Data is entered or edited by airfield staff or owners. Aircraft 1 is underway to Airdrome A. The App has sent a PPR and warns the airfield via the Server. Aircraft 2 is committed to the landing and passes over a row of preprogrammed GPS beacons and code point. This Triggers the payment via the Server to the Airfield Operator.

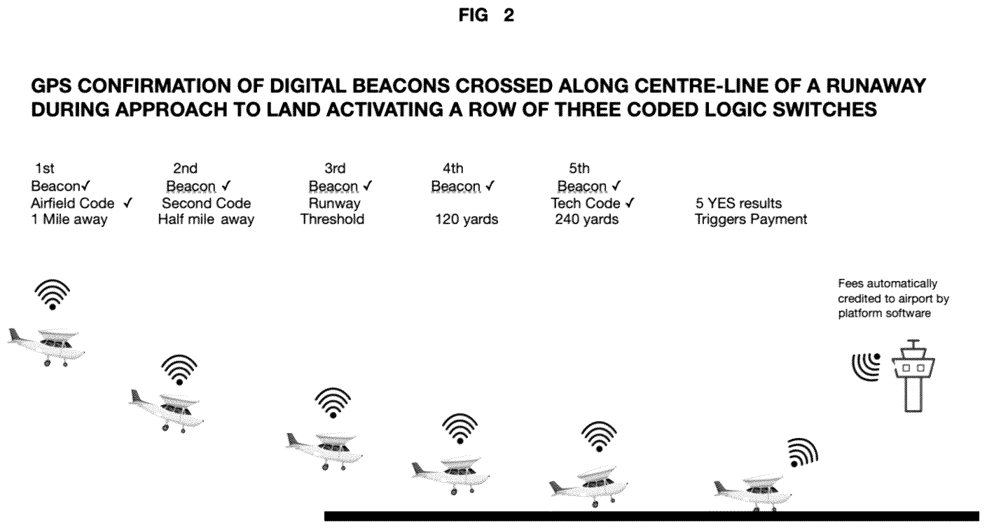

FIG. 2 shows how an aircraft unavoidably crosses the beacon coordinates and registers with the Logic Gates and when they match the e-gate gives a +++++ output as follows:
1 st gate registers airfield code+ and intent to land+
2nd gate registers position over runway threshold+
3rd gate confirms track along runway+
4th gate confirms Technical code whereby a plane ceases to fly+
5th gate confirms landing+

The above five +++++ output triggers paying landing and ramp fees and logging time and place for airfield operator and aircraft owner.

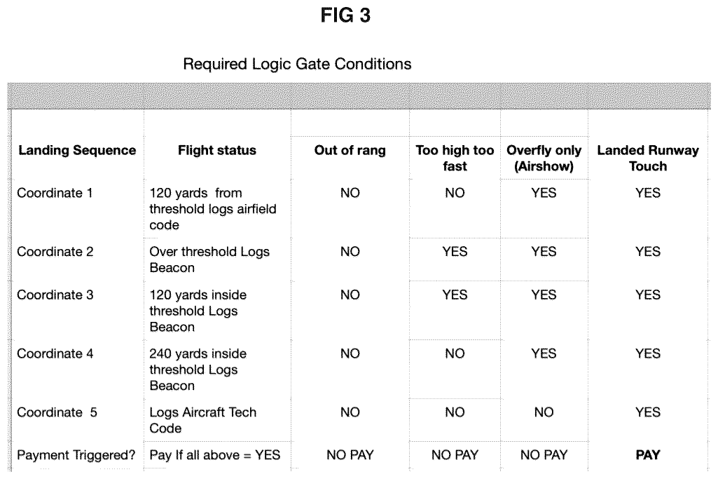

FIG. 3 shows the conditions required to trigger payment. The table shows the five conditions required to recognize a “Landed” status and trigger payment. Failing to fulfil any one of the conditions results in a “not-landed” status.

The logic of the digital gates avoids false billing, such as when:
a) Aircraft en route pass overhead along the runway by coincidence
b) Aircraft abort a landing approach (overshoot)
c) A full stop is not required because a runway is required to be vacated immediately.

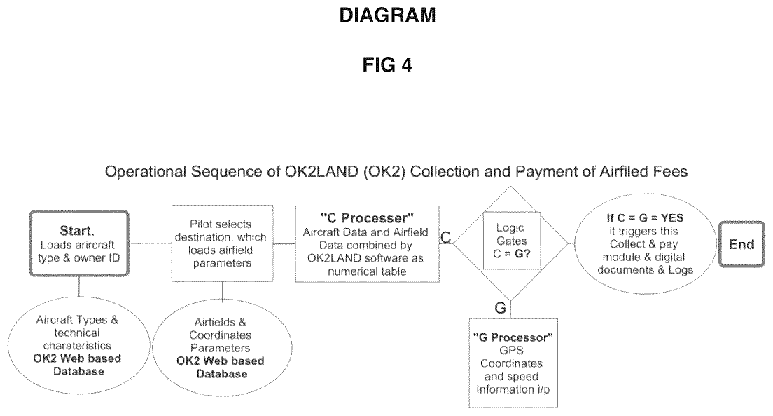

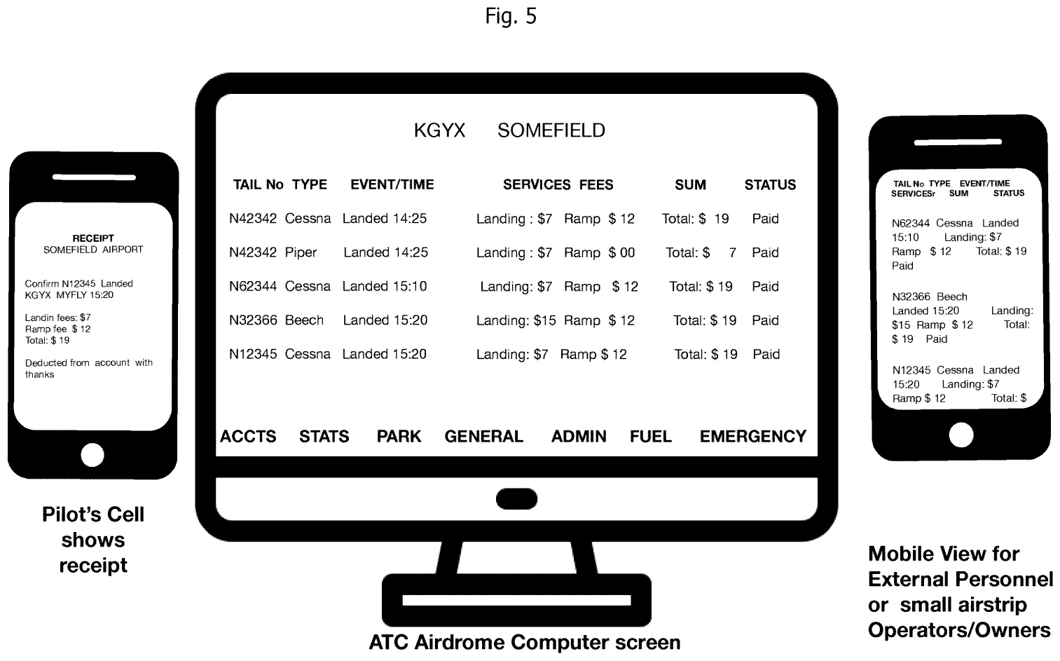

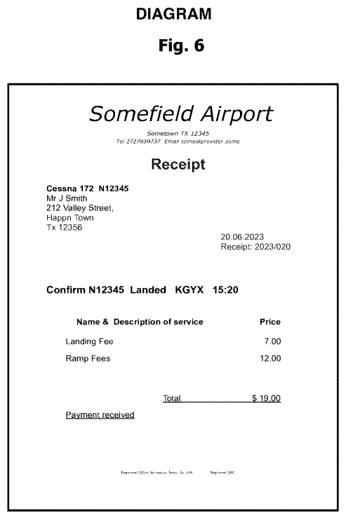

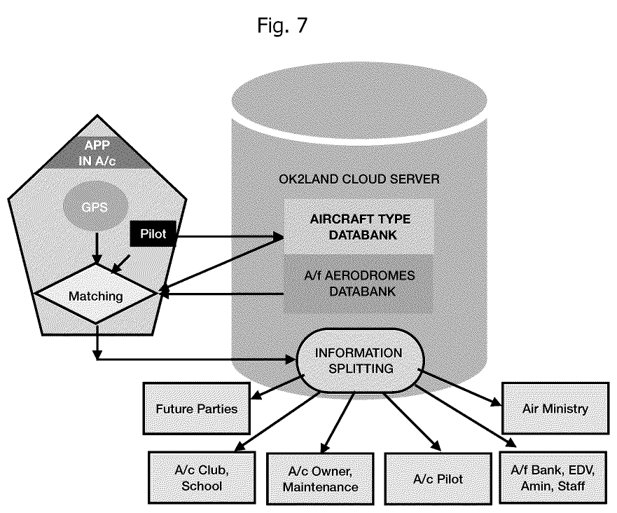

FIG. 4 is a flowchart of the business flow (with further details illustrated in FIGS. 5, 6 and 7) of the method of collecting airfield landing fees and payments using GPS and airfield parameters compared digitally by disclosed logic gates software, and triggering collection and payments according to the disclosure.

I claim:

1. An automatic high-speed safety system, the system comprising apparatus and steps as follows:
at least one microprocessor operatively interengaged with first and second storage locations;
the microprocessor including preprogrammed instructions:
to receive and load into the first storage medium data comprising an aircraft operator provided aircraft type, aircraft owner ID and destination;
to compare the data from the first storage location with data in the second storage location comprising a table of airfield destination data; and
to provide, from the comparison, a package of data for use in preparing and issuing a Prior Permission Request for the operator to land the aircraft at the destination.
